(19) United States
(12) Patent Application Publication
(10) Pub. No.: US 2022/0143925 A1
(43) Pub. Date: May 12, 2022

(54) SUPPORT STRUCTURE FOR 3D FABRICATED OBJECTS

(71) Applicant: Hewlett-Packard Development Company, L.P., Spring, TX (US)

(72) Inventors: Wesley R. Schalk, Vancouver, WA (US); Michael D. Derocher, Corvallis, OR (US); Michael J. Shannon, Vancouver, WA (US)

(73) Assignee: Hewlett-Packard Development Company, L.P., Spring, TX (US)

(21) Appl. No.: 17/418,787

(22) PCT Filed: Jul. 25, 2019
(86) PCT No.: PCT/US2019/043513

§ 371 Date: Jun. 26, 2021

(51) Int. Cl. B29C 64/393; B29C 64/40; B29C 64/336; B29C 64/357

(52) U.S. Cl. CPC B29C 64/393; B29C 64/40; B33Y 10/00; B29C 64/357; B29C 64/336

(57) ABSTRACT

According to examples, an apparatus may include a processor and a memory on which are stored machine-readable instructions that when executed by the processor may cause the processor to access data for a 3D object to be fabricated. The instructions may also cause the processor to determine an orientation that the 3D object is to have relative to a support structure that is to support the 3D object the 3D object. The support structure may have an configuration and may be removed from the 3D object following a post-print processing of the 3D object. The instructions may further cause the support structure to be fabricated in first layers of build material particles and the 3D object to be fabricated in second layers of build material particles.

### BACKGROUND

In three-dimensional (3D) printing, an additive printing process may be used to make 3D solid objects from a digital model. Some 3D printing techniques are considered to be additive processes because they involve the application of successive layers or volumes of a build material, such as a powder or powder-like build material, to an existing surface (or previous layer). 3D printing often includes post-print processing of the 3D objects, for example, to separate powder or powder-like build material from the 3D objects, or the like.

### BRIEF DESCRIPTION OF THE DRAWINGS

Features of the present disclosure are illustrated by way of example and not limited in the following figure(s), in which like numerals indicate like elements, in which:

FIG. 1 shows a block diagram of an example apparatus that may cause fabrication of a support structure and a 3D object or objects;

FIG. 2 shows a diagram of an example 3D fabrication system in which the apparatus depicted in FIG. 1 may be implemented;

FIG. 3 shows an example support structure and 3D objects that the example 3D fabrication system depicted in FIG. 2 may fabricate;

FIG. 4 shows a block diagram of an example support structure that the example 3D fabrication system depicted in FIG. 2 may fabricate;

FIGS. 5A-5D, collectively, show an example process for fabrication of 3D objects using the support structure depicted in FIGS. 3 and 4;

FIG. 6 shows a flow diagram of an example method for fabricating a raft to support 3D objects; and

FIG. 7 shows a block diagram of an example non-transitory computer readable medium on which is stored machine-readable instructions for fabricating a support structure to support a 3D object.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

In 3D printing, such as in powder bed printing, powder may be distributed in thin layers and selected areas of the powder layers may be joined together using an energy absorbing fusing agent, a binder, a thermally or UV curable binder, or the like, to form 3D objects, such as plastic, metal, and/or the like objects. During fabrication, the 3D objects are surrounded by the powder that has not been joined together. Following the formation of the 3D objects, the 3D objects may be removed from the unjoined powder and excess unjoined powder that may unintentionally adhere to 3D objects may be post-print processed to be removed therefrom. In many instances, removal of the unjoined powder may be manually intensive. Furthermore, the 3D objects may undergo post-print processing, e.g., cleaning, sintering, and/or the like, after the powder is selectively joined to form the 3D objects. The post-print processing may also involve movement of and/or access to the 3D objects, which may be challenging, especially in instances in which a large number of 3D objects are fabricated concurrently in a build zone of a 3D fabrication system.

Disclosed herein are apparatuses, methods, and computer readable mediums for facilitating movement and/or access to the 3D objects following the joining of the powder to form the 3D objects, e.g., prior to, during, and/or after the post-print processing on the 3D objects. In some examples, a processor may cause a support structure to be designed digitally on-demand for a 3D object or a plurality of 3D objects. The support structure may enable multiple 3D objects to be moved and/or accessed concurrently, which may facilitate grouping and/or transporting of the 3D objects. Particularly, for instance, the 3D objects may be arranged on the support structure to enable various post-print processing to more efficiently be performed. For example, the support structure may be designed to have an open configuration (e.g., a structure having apertures/openings to allow unjoined powder to pass through the support structure, a lattice structure, a penetrable structure, or the like) to facilitate automatic and/or manual extraction of unjoined, e.g., unbound, unfused, or the like, powder, while enabling multiple 3D objects to be moved and processed together.

The support structure disclosed herein may also include interface features (e.g., a robotic interface) so that the group of 3D objects on the support structure may efficiently be handled together. In some examples, the 3D objects may be nested in groups and arranged in particular orientations on the support structure to allow improved visual and/or physical access to the 3D objects. Furthermore, the support structure may include features such as characterization objects, object labels, and/or the like, to enable improved access, inspections, and/or tracking of the 3D objects during post-print processing.

Through implementation of features of the present disclosure, a support structure may support a 3D object or a plurality of 3D objects to facilitate post-print processing operations such as automatic and/or manual extraction of unbound/unfused powder from the 3D object(s), cleaning of the 3D object(s), finishing of the 3D object(s) (such as painting, bead blasting, solvent/vapor polishing, sintering, and/or dyeing), visual inspections and/or measurement of the 3D object(s), tracking of the 3D object(s), manual/automatic retrieval of the 3D object(s), and/or the like. As a result, through implementation of features of the present disclosure, 3D objects may be fabricated with greater quality (e.g., reduced deformation during sintering, color, texture, and/or the like) as well as greater efficiency and reduced manufacturing costs, which may facilitate automation for mass production of printed 3D objects.

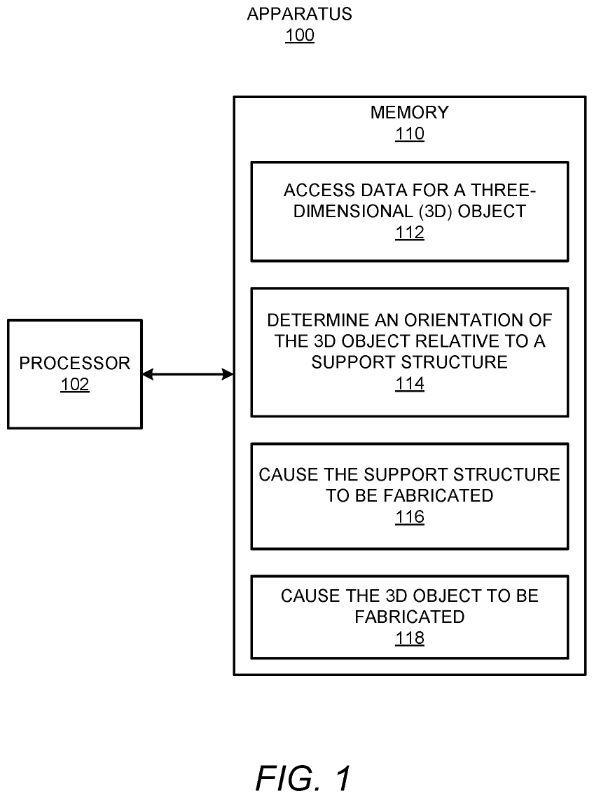

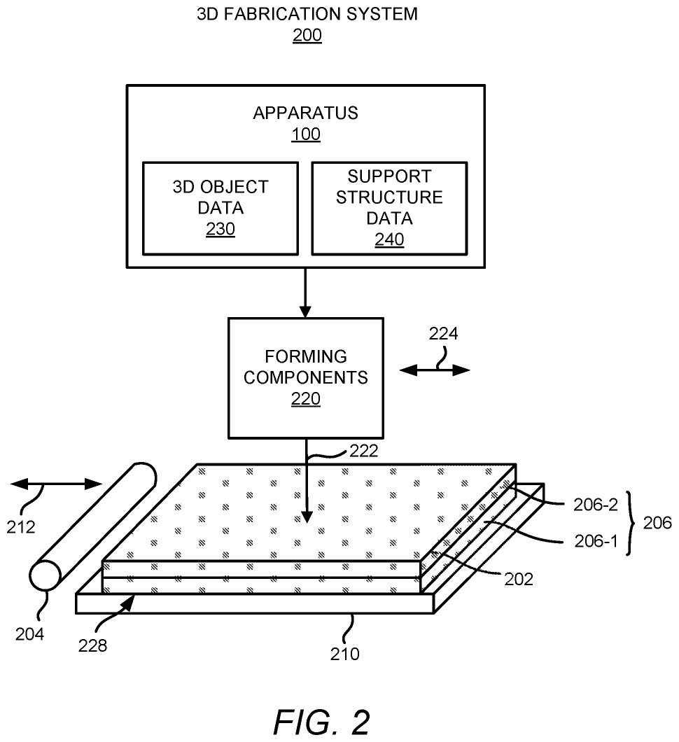

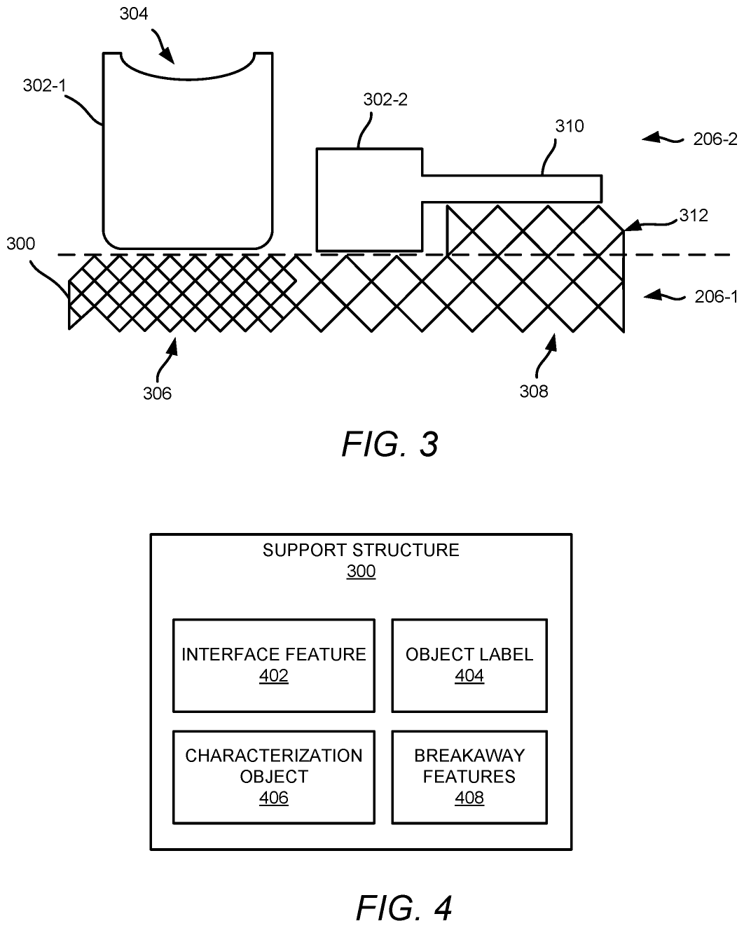

Reference is first made to FIGS. 1-3. FIG. 1 shows a block diagram of an example apparatus 100 that may cause fabrication of a support structure 300 and a 3D object 302 or objects. FIG. 2 shows a diagram of an example 3D fabrication system 200 in which the apparatus 100 depicted in FIG. 1 may be implemented. FIG. 3 shows an example support structure 300 and 3D objects 302 that the example fabrication system 200 depicted in FIG. 2 may fabricate. It should be understood that the example apparatus 100 depicted in FIG. 1, the example 3D fabrication system 200 depicted in FIG. 2, and/or the example support structure 300 depicted in FIG. 3 may include additional features and that some of the features described herein may be removed and/or modified without departing from the scopes of the apparatus 100, the 3D fabrication system 200, and/or the support structure 300.

The apparatus 100 may be a computing device, a tablet computer, a server computer, a smartphone, or the like. The apparatus 100 may also be part of a 3D fabrication system 200, e.g., a control system of the 3D fabrication system 200. Although a single processor 102 is depicted, it should be understood that the apparatus 100 may include multiple processors, multiple cores, or the like, without departing from a scope of the apparatus 100.

The 3D fabrication system 200, which may also be termed a 3D printing system, a 3D fabricator, or the like, may be implemented to fabricate 3D objects through selectively binding and/or solidifying of build material particles 202, which may also be termed particles 202 of build material, together. In some examples, the 3D fabrication system 200 may use energy, e.g., in the form of light and/or heat, to selectively fuse the particles 202. In addition or in other examples, the 3D fabrication system 200 may use binding agents to selectively bind the particles 202. In particular examples, the 3D fabrication system 200 may use fusing agents that increase the absorption of energy to selectively fuse the particles 202.

According to one example, a suitable fusing agent may be an ink-type formulation including carbon black, such as, for example, the fusing agent formulation commercially known as V1Q60A “HP fusing agent” available from HP Inc. In one example, such a fusing agent may additionally include an infra-red light absorber. In one example such fusing agent may additionally include a near infra-red light absorber. In one example, such a fusing agent may additionally include a visible light absorber. In one example, such a fusing agent may additionally include a UV light absorber. Examples of fusing agents including visible light enhancers are dye based colored ink and pigment based colored ink, such as inks commercially known as CE039A and CE042A available from HP Inc. According to one example, the 3D fabrication system 200 may additionally use a detailing agent. According to one example, a suitable detailing agent may be a formulation commercially known as V1Q61A “HP detailing agent” available from HP Inc.

The build material particles 202 may include any suitable material for use in forming 3D objects 302. The build material particles 202 may include, for instance, a polymer, a plastic, a ceramic, a nylon, a metal, combinations thereof, or the like, and may be in the form of a powder or a powder-like material. Additionally, the build material particles 202 may be formed to have dimensions, e.g., widths, diameters, or the like, that are generally between about 5 μm and about 100 μm. In other examples, the particles may have dimensions that are generally between about 30 μm and about 60 μm. The particles may have any of multiple shapes, for instance, as a result of larger particles being ground into smaller particles. In some examples, the particles may be formed from, or may include, short fibers that may, for example, have been cut into short lengths from long strands or threads of material. In addition or in other examples, the particles may be partially transparent or opaque. According to one example, a suitable build material may be PA12 build material commercially known as V1R10A “HP PA12” available from HP Inc.

The 3D fabrication system 200 may include a spreader 204 (e.g., a roller) that may spread the build material particles 202 into layer 206 (also referred to herein as a “build layer”). In some instances, the build material particles 202 may include a mixture of recycled to fresh build material particles, which may reduce manufacturing costs. In some examples, a first layer 206-1 may include a first mix ratio of recycled to fresh build material particles 202 and a second layer 206-2 may have a second mix ratio of recycled to fresh build material particles 202 that is different from the first mix ratio. The build material particles 202 in the first and second layers 206-1, 206-2 may be deposited, e.g., through movement of the spreader 204 across a build platform 210 as indicated by the arrow 212.

As also shown in FIG. 2, the 3D fabrication system 200 may include forming components 220 that may output energy/agent 222 onto the layer 206 as the forming components 220 are scanned across the layer 206 as denoted by the arrow 224. The forming components 220 may also be scanned in the direction perpendicular to the arrow 224 or in other directions.

The fabrication system 200 may include a build zone 228 (e.g., powder bed) within which the forming components 220 may bind and/or solidify the build material particles 202 in the layer 206. The forming components 220 may include, for instance, an energy source, e.g., a laser beam source, a heating lamp, or the like, that may apply energy onto the layer 206.

In addition or alternatively, the forming components 220 may include an agent delivery device to selectively deliver a print agent, such as a fusing agent, onto the build material particles 202 on the layer 206, in which the fusing agent enhances absorption of the energy to cause the build material particles 202 upon which the fusing agent has been deposited to melt. The fusing agent may be applied to the build material particles 202 prior to application of energy onto the build material particles 202. In other examples, the forming components 220 may include a binding agent delivery device that may deposit a binding agent, such as an adhesive that may bind build material particles 202 upon which the binding agent is deposited. In some examples, the binding agent may be a heat and/or light curable agent.

The bound/solidified build material particles 202 may equivalently be termed fused build material particles, bound build material particles, joined build material particles, or the like. The bound/solidified build material particles 202 may be surrounded by build material particles 202 that have not been bound or solidified. These remaining build material particles 202 that have not been bound or solidified may be termed unbound/unfused build material particles, unbound build material particles, or the like. In any regard, the bound/solidified build material particles 202 may be a part of a 3D objects 302 or multiple 3D objects 302-1, 302-2, and the 3D object 302 may be built through selective binding/solidifying of the build material particles 202 in multiple layers 206 of the build material particles 202. As discussed herein, a post-print processing operation may be performed, for instance, to extract the unbound/unfused build material particles 202 from the 3D objects 302. In addition, other post-print processing may be performed while a support structure 300 supports the 3D objects 302.

As shown in FIG. 1, the apparatus 100 may include a processor 102 that may control operations of the apparatus 100. The processor 102 may be a semiconductor-based microprocessor, a central processing unit (CPU), an application specific integrated circuit (ASIC), a field-programmable gate array (FPGA), and/or other suitable hardware device. The apparatus 100 may also include a memory 110 that may have stored thereon machine-readable instructions 112-118 (which may also be termed computer readable instructions) that the processor 102 may execute. The memory 110 may be an electronic, magnetic, optical, or other physical storage device that contains or stores executable instructions. The memory 110 may be, for example, Random Access memory (RAM), an Electrically Erasable Programmable Read-Only Memory (EEPROM), a storage device, an optical disc, and the like. The memory 110, which may also be referred to as a computer readable storage medium, may be a non-transitory machine-readable storage medium, where the term “non-transitory” does not encompass transitory propagating signals.

With reference to FIGS. 1-3, the processor 102 may fetch, decode, and execute the machine-readable instructions 112 to access 3D object data 230 for a 3D object 302 to be fabricated. The processor 102 may access the 3D object data 230 from a data store (not shown). The 3D object data 230 may include information regarding dimensions, shapes, colors, and/or other physical properties of the 3D object 302 to be fabricated.

The processor 102 may fetch, decode, and execute the machine-readable instructions 114 to determine an orientation that the 3D object 302 is to have relative to a support structure 300 based on the 3D object data 230. For instance, the processor 102 may determine how the 3D object 302 is to be oriented with respect to the support structure 300 based on, for instance, the physical configuration of the 3D object 302 as identified in the 3D object data 230. In some examples, the processor 102 may determine characteristics of the 3D object 302 based on the 3D object data 230 and may configure an orientation and/or position of the 3D object 302 to be fabricated in the build zone 228 based on the determined characteristics. For example, the processor 102 may determine that a 3D object 302-1 has a recessed section 304 and may determine that the recessed section 304 is to be visually or physically accessible during post-print processing because the recessed section 304 may cause accumulation of unbound/unfused build material 202 which may be difficult to extract. The processor 102 may cause the 3D object 302-1 to be oriented such that the recessed section 304 faces away from the support structure 300 when fabricated to facilitate post-print processing, such as extraction, inspection, or the like, of the recessed section 304. In other examples, the processor 102 may determine that the 3D object 302 is to have a particular orientation for other purposes, e.g., maximizing packing in the build zone 228, maximizing support of the 3D object 302 on the support structure 300, and/or the like.

In some examples, the processor 102 may determine a configuration of the support structure 300 by which the 3D object 302 is to be supported based on the 3D object data 230. By way of example, the processor 102 may access the support structure data 240 to determine that a support structure 300 is to have a certain configuration that may be suitable to support the 3D object(s) 302 while also enabling the support structure 300 and the 3D object 302 to easily be removed from the unbound/unfused powder in the build zone 228. That is, the support structure 300 may be determined to have an open configuration (e.g., a penetrable configuration) formed of an arrangement of segments with gaps therebetween that may allow unbound/unfused build material particles 202 to pass through the support structure 300.

The processor 102 may also determine an arrangement of segments of the support structure 300 based on the 3D object data 230. For instance, the processor 102 may determine an arrangement of the support structure 300 segments that may result in the support structure 300 adequately supporting the 3D object 302 following the binding/solidifying of the 3D object 302 and removal of the 3D object 302 from the build zone 228. Thus, for instance, the support structure 300 may have a greater density for 3D objects 302 having higher weights.

In some examples, the support structure 300 may have a lattice configuration, which may include segments that may be connected to each other while being spaced apart to form openings through which the unbound/unfused build material particles 202 may pass. In some examples, and as shown in FIG. 3, the segments of the support structure 300 may be arranged to have a regular, e.g., repeating, geometrical configuration.

The processor 102 may fetch, decode, and execute the machine-readable instructions 116 to cause the support structure 300 to be fabricated. In some examples, the support structure 300 may be fabricated in first layers 206-1 (e.g., a first set) of build material particles 202. As illustrated in FIG. 3, the processor 102 may cause the support structure 300 to be fabricated in the first layers 206-1, in which the build material particles 202 in the first layers 206-1 may have a first property. For example, the first layers 206-1 may include a first mix ratio of recycled to fresh build material particles 202, in which the first mix ratio may include a higher percentage of recycled build material particles 202 than a mix ratio of build material particles 202 used to form the 3D objects 302-1, 302-2.

The processor 102 may fetch, decode, and execute the machine-readable instructions 118 to cause the 3D object 302 to be fabricated. In some examples, 3D objects 302-1 and 302-2 may be fabricated in second layers 206-2 (e.g., a second set) of build material particles 202. As illustrated in FIG. 3, the processor 102 may cause the 3D objects 302-1, 302-2 to be fabricated in the second layers 206-2, in which the build material particles 202 in the second layers 206-2 may have a second property. For example, the second layers 206-2 may include a second mix ratio of recycled to fresh build material particles 202, in which the second mix ratio may include a lower percentage of recycled build material particles 202 than the first mix ratio. By way of particular example, the second mix ratio may include no recycled build material particles 202. Thus, for instance, 3D objects 302-1, 302-2 may be fabricated to have a higher quality level than the support structure 300. In some examples, a portion 312 of the support structure 300 may be fabricated in the second layers 206-2 such that the portion 312 of the support structure 300 may be formed of the same mix ratio of build material particles 202 as may be used to fabricate the 3D objects 302.

In other examples, the processor 102 may cause the 3D objects 302-1, 302-2 to be fabricated in some of the same layers as the support structure 300. In these examples, the support structure 300 may be fabricated to extend vertically and/or to include a portion that extends vertically and another section that may extend horizontally.

In some examples, the processor 102 may customize the support structure 300 for each of the 3D objects 302-1 and 302-2 based on the 3D object data 230. For example, the processor 102 may determine an amount of support to be supplied for a 3D object 302 based on, for example, a size, a weight, physical characteristics, and/or the like, of the 3D object 302. By way of particular example, as depicted in FIG. 3, the processor 102 may determine that a first 3D object 301-1 is to be supplied with a greater amount of support than a second 3D object 302-2. In this case, the processor 102 may determine that a first section 306 of the support structure 300 is to have a first arrangement to accommodate the weight, size, and/or physical characteristics of the first 3D object 302-1. For example, the density of the open configuration in the first section 306 of the support structure 300 may be increased relative to a density in a second section 308 that is to support the second 3D object 302-2. For instance, the distances between adjacent segments of the support structure 300 in the first section 306 may be shorter than the distances between adjacent segments of the support structure 300 in the second section 308. In addition, or alternatively, the segments of the support structure 300 in the first section 306 may have larger thicknesses than the segments of the open structure of the support structure 300 may be adjusted based on the determined amount of support to be supplied to the first 3D object 302-1. It should be appreciated that for regions of the support structure 300 that do not support 3D objects 302, the processor 102 may determine that the density of the support structure 300 may be decreased or no support may be fabricated for such regions of the support structure 300, which may result in a reduction in the cost to fabricate the support structure 300 and may enhance an ability to extract unfused/unbound build material particles 202.

In some examples, the processor 102 may determine that the support structure 300 is to have a certain shape based on the shapes of the 3D objects 302. By way of particular example and as depicted in FIG. 3, the processor 102 may determine that additional support is to be provided for the 3D object 302-2 at a particular section, for example, additional support for an overhang 310 of the 3D object 302-2. The processor 102 may determine that the second section 308 of the support structure 300 is to have an additional feature 312 to support the overhang 310 during post-processing operations. The additional feature 312 in the second section 308 may be fabricated to extend to support the overhang 310. As depicted in FIG. 3, the additional feature 312 may be fabricated in the second layers 206-2 of build material particles 202. According to examples, the processor 102 may determine arrangements for the segments of the sections 306, 308 such that the sections 306, 308 may adequately support the respective 3D objects 302-1, 302-2 during the post-print processing while being formed with a minimized amount of material.

Although not explicitly shown, the 3D objects 302 may be attached to the support structure 300 at a number of contact points such that, for instance, the support structure 300 may support the 3D objects 302 as the support structure 300 and the 3D objects 302 are removed from the build zone 228. The 3D objects 302 may remain attached to the support structure 300 during other post-print processing operations. However, the 3D objects 302 may be attached to the support structure 300 via weakened connections such that the 3D objects 302 may be removed from the support structure 300 without damaging the 3D objects 302 following performance of the post-print processing operations. Additionally, or alternatively, the support structure 300 may be fabricated above the 3D objects 302 without departing from a scope of the present disclosure.

Reference is now made to FIG. 4. FIG. 4 shows a block diagram of an example support structure 300 that the example 3D fabrication system 200 depicted in FIG. 2 may fabricate. As shown, the support structure 300 may include an interface feature 402, an object label 404, a characterization object 406, and/or breakaway features 408. It should be understood that the example support structure 300 depicted in FIG. 4 may include additional features and that some of the features described herein may be removed and/or modified without departing from the scopes of the support structure 300.

According to examples, the processor 102 may fetch, decode, and execute the machine-readable instructions 116 to cause the interface feature 402 to be fabricated on the support structure 300. The interface feature 402 may be fabricated on an outer section of the support structure 300 to enable the support structure 300 to be handled to transport multiple 3D objects 302 at the same time. The interface feature 402 may be a feature that may enable manual and/or automated handling of the support structure 300. In some examples, the interface feature 402 may be a robotic interface that may enable a mechanism (e.g., robotic arm) to grab the support structure 300 for handling and transporting of the support structure 300 for post-print processing of the 3D objects 302. For example, the robotic interface may enable an auto-extraction process to automatically remove the support structure 300 and the 3D objects 302 from unbound/unfused build material particles 202 in a build zone 228. In some examples, the interface feature 402 may be provided above the 3D objects 302 to facilitate removal of the 3D objects 302 via the support structure 300 by the robotic interface.

According to examples, the processor 102 may fetch, decode, and execute the machine-readable instructions 116 to cause the object label 404 to be fabricated on the support structure 300. The object label 404 may be fabricated on a surface of the support structure 300 and may include information associated with 3D object 302-1 and/or 3D object 302-2. For instance, the object label 404 may be a revision number of the 3D object 302 (e.g., “Rev. 1.1”), a barcode, text, human readable plaques, and/or the like. The object label 404 may be fabricated to enable a particular 3D object 302 to be traceable along the fabrication and post-print processing operations. In some examples, similar or related 3D objects 302 may be nested or grouped together on the support structure 300, and an object label 404 may provide information pertaining to a group of 3D objects 302.

According to examples, the processor 102 may fetch, decode, and execute the machine-readable instructions 116 to cause the characterization object 406 to be fabricated on the support structure 300. The characterization object 406 may provide information regarding a characteristic of a 3D object 302. For example, the characterization object 406 may provide information regarding an attribute of a 3D object 302 on the support structure 300. In certain examples, the characterization object 406 may be a three-legged coupon (e.g., a XYZ directions) that enables visualization of dimensions of the 3D object 302 on the support structure 300. The characterization object 406 may provide other types of information regarding the 3D object 302 including, for example, tensile strength, elongation of break, fit, and/or the like.

According to examples, the processor 102 may fetch, decode, and execute the machine-readable instructions 116 to cause the breakaway features 408 to be fabricated on the support structure 300 at contact points with the 3D objects 302. The breakaway features 408 may enable the 3D object 302 to more easily be separated from the support structure 300. For instance, the breakaway features 408 may have smaller widths, lower densities, greater brittleness, and/or the like, as compared with the segments of the support structure 300.

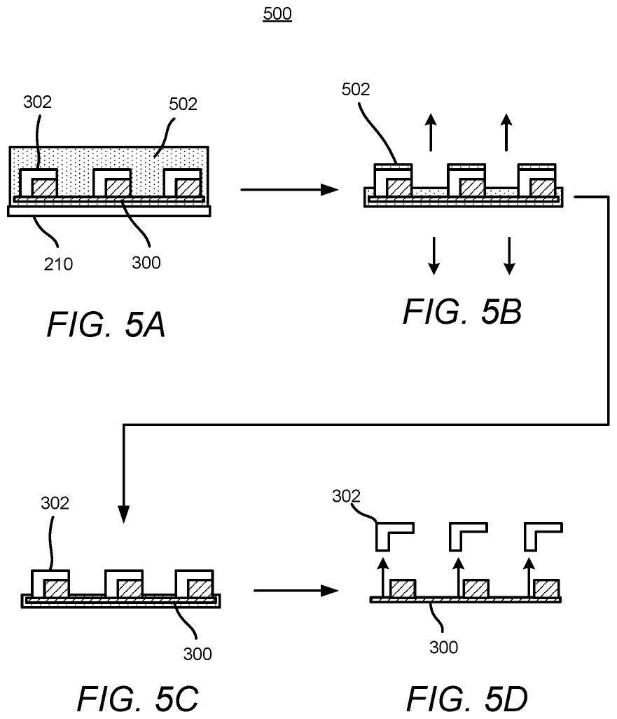

Reference is now made to FIGS. 5A-5D, which, collectively, show an example process for fabrication of 3D objects 302 using the support structure 300 depicted in FIGS. 3 and 4. It should be understood that the example process 500 depicted in FIGS. 5A-5D may include additional features and that some of the features described herein may be removed and/or modified without departing from the scope of the process 500.

As illustrated in FIG. 5A, a plurality of 3D objects 302 may be fabricated together with a support structure 300 on a build platform 210 of a 3D fabrication system 200 in a layer-by-layer basis. The 3D fabrication system 200 may fabricate the 3D objects 302 and the support structure 300 in a build zone 228 of build material layers 206 in any of the manners discussed herein. The plurality of 3D objects 302 may be coupled to the support structure 300 to enable various post-print processing including, for example, automatic/manual extraction of unbound/unfused powder from the printed objects, cleaning of printed objects, finishing of printed object (such as painting, bead blasting, solvent polishing, or dyeing), visual inspections and/or measurement of printed objects, object tracking, and manual/automatic retrieval of printed objects.

Referring to FIG. 5B, the support structure 300 may have an open configuration that may enable extraction of the support structure 300 and the 3D objects 302 from unbound/unfused build material particles 502. In addition, the open configuration may facilitate removal of unbound/unfused build material particles 502 from the 3D objects 302. In some examples, the processor 102 may cause an auto-extraction process, e.g., extraction by a robotic arm, to be performed to remove the support structure 300 and the 3D objects 302 from the unbound/unfused build material particles 502.

In some examples, as illustrated in FIG. 5C, post-print processing may be performed to remove additional unbound/unfused build material particles 502, for example, by manual cleaning using air or a vacuum. The 3D objects 302 may be arranged in a particular orientation/position on the support structure 300, in various manners as described herein. The arrangement of the 3D objects 302 on the support structure 300 may enable visual inspections and/or measurements of the 3D objects, obtain information on the 3D objects 302 such as for object tracking, and/or the like. In some examples, the plurality of 3D objects 302 may be transported as a group for additional post-print processing on the support structure 300. Post-print processing of the 3D objects 302 may include vapor polishing, bead blasting, dyeing, sintering, or the like. In some examples, the support structure 300, which may be fabricated using the same materials as the 3D objects 302, may function as a live setter in a sintering process in which the dimensions of the support structure 300 may change proportionately to the dimension changes of the 3D objects 302, thereby reducing deformations in the finished product.

In some examples, as illustrated in FIG. 5D, the 3D objects 302 may be removed from the support structure 300. The 3D objects 302 may be removed manually and/or by a robot.

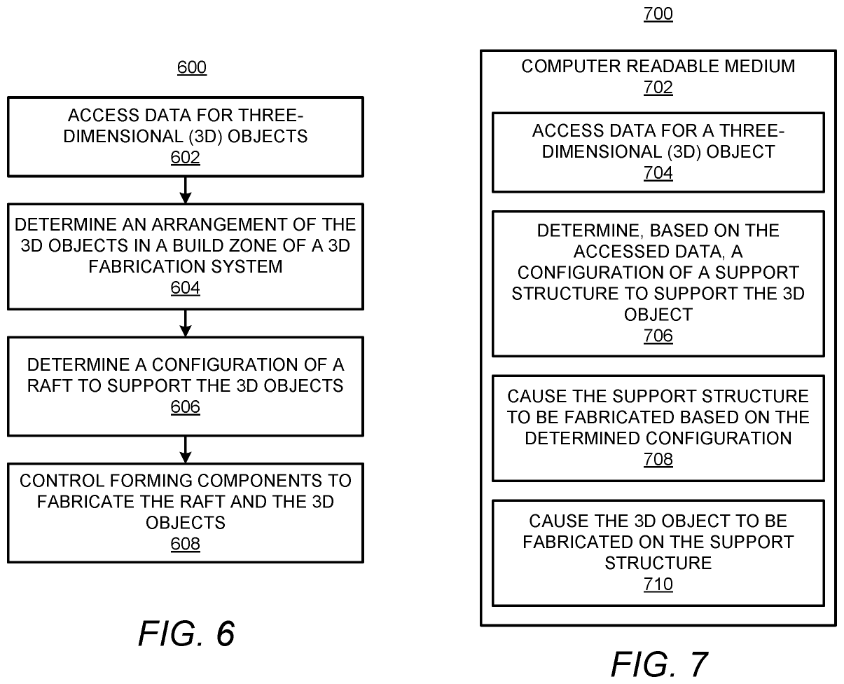

Turning now to FIG. 6, there is a flow diagram of an example method 600 for forming a raft to support 3D objects 302. It should be understood that the method 600 depicted in FIG. 6 may include additional operations and that some of the operations described therein may be removed and/or modified without departing from the scope of the method 600. The description of the method 600 is also made with reference to the features depicted in FIGS. 1-4 for purposes of illustration. Particularly, the processor 102 of the apparatus 100 may execute some or all of the operations included in the method 600.

At block 602, the processor 102 may access data 230 for 3D objects 302 to be fabricated. The processor 102 may access the data 230 from a data storage (not shown). At block 604, the processor 102 may determine an arrangement of the 3D objects 302 to be fabricated in a build zone 228 of a 3D fabrication system 200 based on the accessed data 230 in any of the manners discussed herein.

At block 606, the processor 102 may determine a configuration of a raft (which may be equivalent to the support structure 300), to support the 3D objects 302 during post-print processing of the 3D objects 302 based on the determined arrangement of the 3D objects 302. The processor 102 may access the support structure data 240 to determine that a raft 300 is to have a certain configuration that may be suitable to support the 3D objects 302 while also enabling the raft 300 and the 3D objects 302 to readily be removed from the unbound/unfused powder in the build zone 228. The raft 300 and may support the 3D objects 302 from a particular side (e.g., top, side, and/or bottom of the 3D objects 302). Thus, for instance, the raft 300 may be determined to extend horizontally and/or vertically (e.g., the raft 300 may have a portion that extends horizontally and a portion that extends vertically). In some examples, the support structure 300 may have an open or penetrable configuration (e.g., a lattice configuration) and may include contact points (e.g., breakaway features 408) to support the 3D objects 302 on the raft 300 during post-print processing.

At block 608, the processor 102 may control the forming components 220 to fabricate the raft 300 based on the determined configuration and to fabricate the 3D objects to be supported by the raft based on the determined arrangement. In some examples, the processor 102 may control the forming components 220 to fabricate the raft 300 in first layers 206-1 of build material particles 202 and may control the forming components 220 to fabricate the 3D objects 302 to be supported by the raft 300 based on the determined arrangement in second layers 206-2 of the build material particles 202.

In some examples, the processor 102 may determine support levels for the 3D objects 302 based on the accessed data 230 for the 3D objects 302, and may determine an arrangement of a lattice configuration for the penetrable structure (e.g., support structure sections 306, 308, 312) based on the determined support level for the 3D objects 302. The support levels may be, for instance, the weights of the 3D objects 302.

In some examples, to determine the arrangement of the raft 300 to support the 3D objects 302, the processor 102 may determine support levels for the 3D objects based on the accessed data 230 for the 3D objects 302 and may determine a number of contact points (e.g., breakaway features 408) to support the 3D objects 302 based on the determined support levels for the 3D objects 302.

In some examples, the processor 102 may control the forming components 220 to fabricate the raft 300 in first layers 206-1 of build material particles 202 having a first mix ratio of recycled to fresh build material particles. In some examples, the processor 102 may control the forming components 220 to fabricate the 3D objects 302 and/or the raft 300 in second layers 206-2 of build material particles 202 having a second mix ratio of recycled to fresh build material particles. In some examples, the second mix ratio may be different from the first mix ratio and may have less or no recycled build material particles 202 relative to the first mix ratio in the first layer 206-1.

Some or all of the operations set forth in the method 600 may be contained as utilities, programs, or subprograms, in any desired computer accessible medium. In addition, the method 600 may be embodied by computer programs, which may exist in a variety of forms. For example, the method 600 may exist as machine-readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

Turning now to FIG. 7, there is shown a block diagram 700 of an example non-transitory computer readable medium 702 on which is stored machine-readable instructions 704-710 for fabricating a support structure 300 to support a 3D object 302. The processor 102 may execute the machine-readable instructions 704-710. Particularly, the processor 102 may execute the instructions 704 to access data 230 for a 3D object 302 to be fabricated. The processor 102 may execute instructions 706 to determine a configuration of a support structure 300 to support the 3D object 302 based on the accessed data 230. The processor 102 may determine the configuration of the support structure 300 including an arrangement of segments of the support structure 300 to accommodate particular 3D objects 302-1, 302-1 in any of the manners as described herein. In some examples, the processor 102 may execute instructions 708 to cause the support structure 300 to be fabricated based on the determined configuration of the support structure 300. In some examples, the processor 102 may execute the instructions 710 to cause the 3D object 302 to be fabricated on the support structure 300.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

What is claimed is:

1. An apparatus comprising:
a processor; and
a memory on which are stored machine-readable instructions that when executed by the processor, cause the processor to:
access data for a three-dimensional (3D) object to be fabricated;
determine an orientation that the 3D object is to have relative to a support structure that is to support the 3D object, the support structure having an open configuration, wherein the determined orientation is to cause the support structure to support the 3D object during post-print processing of the 3D object and wherein the support structure is to be removed from the 3D object following the post-print processing of the 3D object;
cause the support structure to be fabricated in first layers of build material particles; and
cause the 3D object to be fabricated in second layers of build material particles.

2. The apparatus of claim 1, wherein the instructions are further to cause the processor to:
cause the support structure to be fabricated using first build material particles having a first property; and
cause the 3D object to be fabricated using second build material particles having a second property that is different than the first property.

3. The apparatus of claim 2, wherein the instructions are further to cause the processor to cause a portion of the support structure to be fabricated in the second layers of the build material particles having the second property, wherein the first property is a first ratio of recycled to fresh build material particles and the second property is a second ratio of recycled to fresh build material particles.

4. The apparatus of claim 1, wherein the instructions are further to cause the processor to:
determine a support level for the 3D object;
determine an arrangement of segments of the open configuration based on the determined support level for the 3D object; and
cause the support structure to be fabricated to have the determined arrangement of segments.

5. The apparatus of claim 1, wherein the instructions are further to cause the processor to:
determine a section of the 3D object that is to be accessible during the post-print processing; and
determine the orientation that the 3D object is to have relative to the support structure to orient the determined section away from the support structure.

6. The apparatus of claim 1, wherein the instructions are further to cause the processor to:
cause an interface feature to be fabricated on the support structure, the interface feature to be held by a mechanism for handling the support structure during transport of the support structure and the 3D object.

7. The apparatus of claim 1, wherein the instructions are further to cause the processor to:
cause an object label to be fabricated on the support structure, the object label to include information associated with the 3D object.

8. The apparatus of claim 1, wherein the instructions are further to cause the processor to:
cause a characterization object to be fabricated on the support structure, the characterization object being associated with the 3D object and having a physical attribute that is the same as a physical attribute of the 3D object.

9. The apparatus of claim 1, wherein the instructions are further to cause the processor to:
access data for a second 3D object to be fabricated;
determine a first region on the support structure to support the 3D object and a second region on the support structure to support the second 3D object;
determine a first arrangement of segments of the open configuration for the first region to support the 3D object; and
determine a second arrangement of segments of the porous configuration for the second region to support the second 3D object, the second arrangement differing from the first arrangement.

10. A method comprising:
accessing, by a processor, data for three-dimensional (3D) objects to be fabricated;
determining, by the processor, an arrangement of the 3D objects to be fabricated in a build zone of a 3D fabrication system based on the accessed data;
determining, by the processor, a configuration of a raft to support the 3D objects during post-print processing of the 3D objects based on the determined arrangement of the 3D objects, the raft having a lattice configuration and contact points to support the 3D objects during post-print processing of the 3D objects;
and controlling, by the processor, forming components to fabricate the raft based on the determined configuration and to fabricate the 3D objects to be supported by the raft based on the determined arrangement.

11. The method of claim 10, wherein determining the configuration of the raft to support the 3D objects further comprises:
determining support levels for the 3D objects based on the accessed data for the 3D objects; and
determining an arrangement of the lattice configuration for the raft based on the determined support levels for the 3D objects.

12. The method of claim 10, wherein determining the configuration of the raft to support the 3D objects during post-print processing of the 3D objects comprises:
determining support levels for the 3D objects based on the accessed data for the 3D objects; and
determining a number of contact points to support the 3D objects based on the determined support levels for the 3D objects.

13. The method of claim 10, further comprising:
controlling the forming components to fabricate the raft in first layers of build material particles, the first layers of build material particles having a first mix ratio of recycled to fresh build material particles; and
controlling the forming components to fabricate the 3D objects and/or a portion of the raft in second layers of build material particles having a second mix ratio of recycled to fresh build material particles, the second layers of build material particles having second mix ratio of recycled to fresh build material particles, the second mix ratio differing from the first mix ratio.

14. A three-dimensional (3D) fabrication system comprising:
forming components; and
a processor to:
access data for a 3D object to be fabricated;
determine a property of the 3D object based on the accessed data;
determine an arrangement of a support structure to support the 3D object during post-print processing of the 3D object based on the determined property of the 3D object;
control the forming components to fabricate the support structure according to the determined arrangement of the support structure in a first set of build material particle layers; and
control the forming components to fabricate the 3D object to be supported by the support structure in a second set of build material particle layers.

15. The 3D fabrication system of claim 14, wherein the processor is further to:
control the forming components to fabricate the support structure using a first ratio of recycled to fresh build material particles; and
control the forming components to fabricate the 3D object and/or a portion of the support structure using a second ratio of recycled to fresh build material particles, the second ratio differing from the first ratio.
